(19) United States
(12) Patent Application Publication
(10) Pub. No.: US 2020/0332400 A1
(43) Pub. Date: Oct. 22, 2020

(54) OPTIMIZED WELD STRENGTH FOR DISSIMILAR MATERIALS

(71) Applicant: Apple Inc., Cupertino, CA (US)

(72) Inventors: Zechariah D. Feinberg, San Francisco, CA (US); Abhijeet Misra, Sunnyvale, CA (US); Lei Gao, Shanghai (CN); Matthew D. Walker, Los Gatos, CA (US); Logan Ames, Palo Alto, CA (US); Duy P. Le, Los Angeles, CA (US); Vince Yan, San Francisco, CA (US)

(21) Appl. No.: 16/533,374

(22) Filed: Aug. 6, 2019

Related U.S. Application Data
(60) Provisional application No. 62/835,931, filed on Apr. 18, 2019.

(51) Int. Cl. C22C 38/16; B23K 26/21; B23K 26/06

(52) U.S. Cl. CPC C22C 38/16; B23K 26/0604; B23K 26/21

(57) ABSTRACT

An electronic device can include a component including a first material joined to a component including a second, different material. The first material can include steel and copper, while the second material can include aluminum. The first material can be joined to the second material by a pulsed laser welding process that forms an interface region having a ratio of an interface region length to a lateral length greater than about 1.4.

### CROSS-REFERENCE TO RELATED APPLICATION(S)

This claims priority to U.S. Provisional Patent Application No. 62/835,931, filed 18 Apr. 2019, and entitled “OPTIMIZED WELD STRENGTH FOR DISSIMILAR MATERIALS,” the entire disclosure of which is hereby incorporated by reference.

### FIELD

The described examples relate generally to electronic devices. More particularly, the present examples relate to joining dissimilar materials for electronic devices.

### BACKGROUND

Electronic devices, including portable electronic devices such as handheld phones, tablet computers, and watches endure a number of stresses during everyday use. These devices not only experience contact with various surfaces, but the use, transportation, and storage of such devices can expose them to various mechanical and thermal stresses. Structural components of such devices can be designed to withstand these various stresses. For example, stiff and strong internal components can be included to prevent flexure of the device. Electronic devices also typically include components that have desired thermal properties to manage and distribute heat generated by the device. In some examples, it can be desirable to include components that serve both thermal and structural functions.

The materials used to achieve these desired component properties are often not the same materials as used in other portions of the device. Further, it can be desirable to join together various components made from different materials to achieve a desired level of both thermal and structural performance. While there are many traditional methods for joining similar materials together, these methods rarely achieve a desired level of performance when used to join dissimilar materials. Accordingly, it can be desirable to provide methods of joining dissimilar materials that can achieve a desired level of both strength and durability.

### SUMMARY

According to some aspects of the present disclosure, an electronic device can include a first metallic material, a second, different metallic material joined to the first metallic material, and an interface region between the first metallic material and the second metallic material having a ratio of an interface region length to a lateral length of at least about 1.4.

In some examples, a cross-sectional area of the first and second metallic materials along the entire interface region length contains a region of intermetallic material having an area of less than about 5.5 times the interface region length. The interface region can include less than about 25 weight percent (wt %) aluminum. The interface region can have a hardness less than about 2.5 times the hardness of the first material. The first material includes aluminum and the second material can include one or both of steel and copper. The interface region can include one or more peaks of the first material extending into the second material, the peaks having an average extension into the second material of less than about 100 microns. The peaks can have an average extension into the second material of less than about 75 microns. The interface region length can be at least about 3500 microns. The interface region length can be at least about 4000 microns.

According to some aspects of the present disclosure, a method of joining two dissimilar metallic materials can include disposing a first metallic material adjacent to a second, different metallic material, and exposing at least the first metallic material to at least one nanosecond laser pulse to form an interface region between the first and second metallic materials having a ratio of an interface region length to a lateral length of at least about 1.4.

In some examples, a push force of the nanosecond laser pulse is greater than about 50 kilogram-force (kgf). The nanosecond laser pulse can have a duration of from about 200 nanoseconds to about 300 nanoseconds. The nanosecond laser pulse can have a duration of about 240 nanoseconds. The nanosecond laser pulse can have a power of from about 75 microjoules (μJ) to about 100 μJ. A focal position of the nanosecond laser pulse can be between about 0.5 mm above a surface of the second metallic material and about 0.5 mm below a surface of the second metallic material. A cross-sectional area of the first and second metallic materials along the entire interface region length can contain a region of intermetallic material having an area of less than about 5.5 times the interface region length. The interface region can include less than about 25 weight percent (wt %) aluminum.

According to some aspects of the present disclosure, an interface region between a first metallic material and second, different metallic material can have a ratio of an interface region length to a lateral length of at least about 1.4. In some examples, the first metallic material can include stainless steel and copper and the second metallic material can include aluminum. The ratio of the interface region length to the lateral length can be at least about 1.8.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a top perspective view of an electronic device.

FIG. 2 shows an exploded view of an electronic device.

FIG. 3 shows an exploded view of a portion of an electronic device.

FIG. 4A shows a cross-sectional view of a first material adjacent to a second material.

FIG. 4B shows a cross-sectional view of a first material adjacent to a second material.

FIG. 5A shows a cross-sectional view of a first material partially joined to a second material.

FIG. 5B shows a cross-sectional view of a first material partially joined to a second material.

FIG. 6 shows a cross-sectional view of a first material joined to a second material along an interface region.

FIG. 7 shows a cross-sectional view of a first material joined to a second material along an interface region.

FIG. 8 shows a cross-sectional view of a first material joined to a second material along an interface region including a region of intermetallic material.

FIG. 9 shows a cross-sectional view of a first material joined to a second material along an interface region including a region of intermetallic material.

FIG. 10 shows a plot of material hardness versus distance along a cross-section of an interface region between a first material joined to a second material.

FIG. 11 shows a plot of second material concentration versus distance along a cross-section of an interface region between a first material joined to a second material.

FIG. 12 shows a process flow diagram of a process for joining a first material to a second, different material.

### DETAILED DESCRIPTION

The present description provides examples, and is not limiting of the scope, applicability, or configuration set forth in the claims. Thus, it will be understood that changes can be made in the function and arrangement of elements discussed without departing from the spirit and scope of the disclosure, and various embodiments can omit, substitute, or add other procedures or components as appropriate. For instance, methods described can be performed in an order different from that described, and various steps can be added, omitted, or combined. Also, features described with respect to some embodiments can be combined in other embodiments.

One aspect of the present disclosure relates to an electronic device including a copper and stainless steel clad material joined to an aluminum material. The dissimilar clad and aluminum materials are joined using a nanosecond pulsed laser welding process that forms an interface region between the two materials. The interface region can have a structure, for example, a jagged or saw tooth structure, such that the total length of the interface region across a cross-sectional cut or view of the interface region is longer than a linear lateral distance or length between two endpoints of the a cross-sectional cut or view of the interface region. The ratio of the interface region length to the lateral length can be at least about 1.4 and the interface region can include a low concentration of intermetallic material. Further, the interface region between the clad and aluminum can have less than about 25 weight percent (wt %) aluminum and can have a hardness less than about 2.5 times the hardness of the aluminum.

Accordingly, a strong and durable interface can be formed between two dissimilar metallic materials to join them together. In some examples, the methods and process for joining dissimilar materials described herein can be used to form an interface region between the materials that traditional joining methods cannot durably or reliably join, thereby eliminating or reducing the need for additional processing or other methods of joining. For example, the processes for joining dissimilar materials described herein can eliminate or reduce the need for an intermediate material or component to join the dissimilar materials. In some examples, the dissimilar materials can be a part of separate components of an electronic device that are joined together using the processes described herein. In some examples, however, two dissimilar materials can be joined to form a single component or part of an electronic device.

The terms ‘different’ and ‘dissimilar’ are used herein with respect to the comparison of materials to indicate that the materials do not have the same composition. That is, a first material and a second, different material are materials that do not have identical or substantially identical compositions or chemical makeups. In some cases, the terms ‘different’ and ‘dissimilar’ can refer to materials consisting of different elements or of the same elements in different amounts. For example, as used herein steel and aluminum are different materials.

The ability to directly join two dissimilar metallic materials together in a strong and reliable way can allow for the construction of electronic devices having desirable structural, electrical, and thermal properties. For example, the first material can be a structural component of an electronic device that can be joined to a second component including a second, different material to provide a desirable level of stiffness to the device without the need for additional fastening members, adhesives, or other structural components. The first material can thus be selected based on desired material or mechanical properties, such as a desired Young's modulus. Whereas traditional methods of joining dissimilar materials might limit the available material choices for a component to which this first material is joined, the processes described herein can allow for a strong and durable interface to be formed with a second, dissimilar material. This second material can also be selected based on other properties, such as low cost or weight. In this way, the processes described herein can reduce the material costs and processing time associated with manufacturing electronic devices, while also achieving a desired level of structural performance.

Further, in some examples, the first material can be selected to have desired thermal properties that enable a component including the first material to act as a thermal sink for components of the device. For example, such a component can transport or dissipate heat generated by a component or components of the device. The interface region between the component including the first material and one or more components including a second, different material, can thus allow for improved thermal performance of the device, with a reduced or eliminated need for additional materials or components. Again, traditional methods of joining materials can either limit the available materials to be joined, thereby resulting in undesirable levels of thermal performance, or can require additional time or materials, thereby increasing costs or device size.

In some examples, two components including dissimilar materials can be joined along an interface region to produce an electrical contact or connection between the two components. An electrical connection between two components including dissimilar materials can, for example, form part of an antenna assembly or provide other functionality to an electronic device. As such, the performance of one or more functions of an electronic device can at least partially depend on the interface region between a first material and a second, different material. An electronic device can experience a variety of stresses during everyday use, and can, for example, be subject to relatively high stresses during particular events, such as accidental drops. In order to ensure that the device performance is not negatively impacted by these stresses, it can be important that the interface region between two dissimilar materials does not break or decouple. Even though two components can be joined by a large number of interface regions formed by the processes described herein, the failure of even one interface region, or a portion of an interface region, can negatively impact device performance. Accordingly, the strong and reliable interface regions between dissimilar materials described herein can reduce or eliminate the risk of performance reduction due to mechanical stresses on the device.

In some examples, a first material can be selected such that a component including the first material can be joined to a second, different material to achieve desired levels of structural, thermal, and electrical performance. For example, a first material can be selected to have desired mechanical and thermal properties and can be joined to a second, different material that has been selected to have desired material properties such as weight or machineability, by an interface region that provides for a strong and durable mechanical, thermal, and electrical connection. In such examples, the processes for joining dissimilar materials described herein can allow for a reduced number of components in a device, or for device architectures that achieve desired levels or performance while reducing costs and device size, or providing additional benefits.

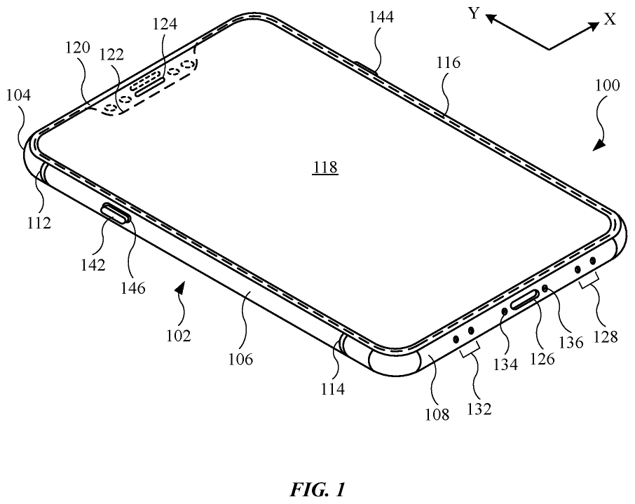

These and other examples are discussed below with reference to FIGS. 1-12. The detailed description given herein with respect to these figures, however, is for explanatory purposes only and should not be construed as limiting.

FIG. 1 illustrates a top perspective view of an exemplary electronic device 100. The electronic device 100 shown in FIG. 1 is a mobile wireless communication device, such as a smartphone. The smartphone of FIG. 1 is merely one representative example of a device that can be used in conjunction with the systems and methods disclosed herein. Electronic device 100 can correspond to any form of wearable electronic device, a portable media player, a media storage device, a portable digital assistant (“PDA”), a tablet computer, a computer, a mobile communication device, a GPS unit, a remote control device, or any other electronic device. The electronic device 100 can be referred to as an electronic device, or a consumer device.

The electronic device 100 can have a housing that includes a band or a frame 102 that defines an outer perimeter of the electronic device 100. The band 102, or portions thereof, can be joined to one or more other components of the device, as described herein. In some examples, the band 102 can include several sidewall components, such as a first sidewall component 104, a second sidewall component 106, a third sidewall component 108 (opposite the first sidewall component 104), and a fourth sidewall component (not shown in FIG. 1). The aforementioned sidewall components can be joined, for example, at multiple locations, to one or more other components of the device, as described herein.

In some instances, some of the sidewall components form part of an antenna assembly (not shown in FIG. 1). As a result, a non-metal material or materials can separate the sidewall components of the band 102 from each other to electrically isolate the sidewall components. For example, a first separating material 112 separates the first sidewall component 104 from the second sidewall component 106, and a second separating material 114 separates the second sidewall component 106 from the third sidewall component 108. The aforementioned materials can include an electrically inert or insulating material(s), such as plastics and/or resin, as non-limiting examples. Further, as described herein, one or more of the sidewall components can be electrically connected to internal components of the electronic device, such as a support plate. These electrical connections can be achieved by joining a sidewall component to an internal component, for example, as part of the antenna assembly.

The electronic device 100 can further include a display assembly 116 (shown as a dotted line in FIG. 1) that is covered by a protective cover 118. The display assembly 116 can include multiple layers, with each layer providing a unique function. The display assembly 116 can be partially covered by a border 120 or a frame that extends along an outer edge of the protective cover 118 and partially covers an outer edge of the display assembly 116. The border 120 can be positioned to hide or obscure any electrical and/or mechanical connections between the layers of the display assembly 116 and flexible circuit connectors. Also, the border 120 can include a uniform thickness. For example, the border 120 can include a thickness that generally does not change in the X- and Y-dimensions.

FIG. 1 also shows that the display assembly 116 can include a notch 122, representing an absence of the display assembly 116. The notch 122 can allow for a vision system that provides the electronic device 100 with information for object recognition, such as facial recognition. In this regard, the electronic device 100 can include a masking layer with openings (shown as dotted lines near opening 124) designed to hide or obscure the vision system, while the openings allow the vision system to provide the object recognition information. Also, the protective cover 118 can be formed from a transparent material, such as glass, plastic, sapphire, or the like. In this regard, the protective cover 118 can be referred to as a transparent cover, a transparent protective cover, or a cover glass (even though the protective cover 118 often does not include glass material). As shown in FIG. 1, the protective cover 118 includes an opening 124, which can be a single opening 124 of the protective cover 118. The opening 124 can allow for transmission of acoustical energy (in the form of audible sound) into the electronic device 100, which can be received by a microphone (not shown in FIG. 1) of the electronic device 100. The opening 124 can also, or alternatively, allow for transmission of acoustical energy (in the form of audible sound) out of the electronic device 100, which can be generated by an audio module (not shown in FIG. 1) of the electronic device 100.

The electronic device 100 can further include a port 126 designed to receive a connector of a cable assembly. The port 126 allows the electronic device 100 to communicate data (send and receive), and also allows the electronic device 100 to receive electrical energy to charge a battery assembly. Accordingly, the port 126 can include terminals that electrically couple to a connector.

Also, the electronic device 100 can include several additional openings. For example, the electronic device 100 can include openings 128 that allow an additional audio module (not shown in FIG. 1) of the electronic device to emit acoustical energy out of the electronic device 100. The electronic device 100 can further include openings 132 that allow an additional microphone of the electronic device to receive acoustical energy. Furthermore, the electronic device 100 can include a first fastener 134 and a second fastener 136 designed to securely engage with a rail that is coupled to the protective cover 118. In this regard, the first fastener 134 and the second fastener 136 are designed to couple the protective cover 118 with the band 102.

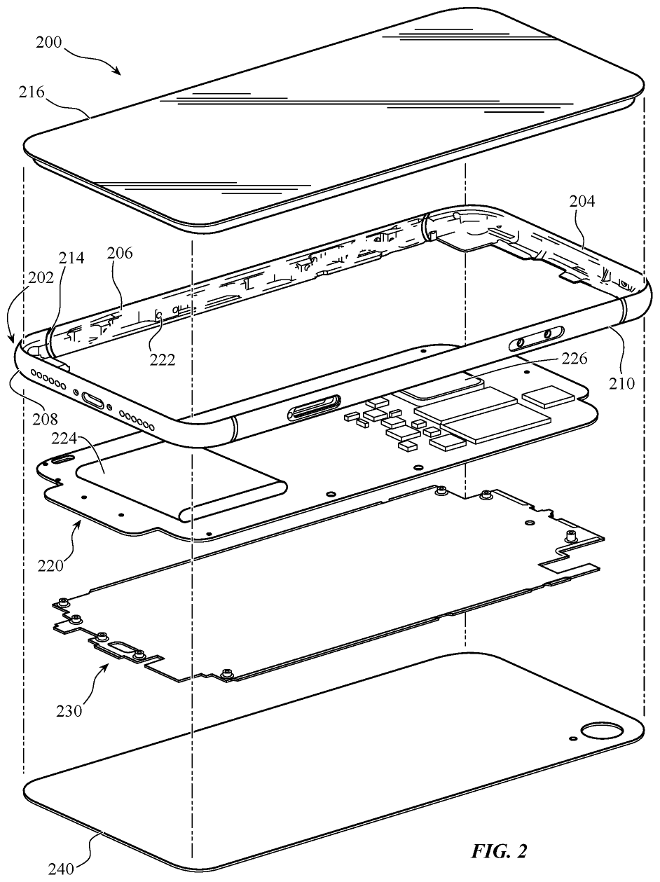

The electronic device 100 can include several control inputs designed to facilitate transmission of a command to the electronic device 100. For example, the electronic device 100 can include a first control input 142 and a second control input 144. The aforementioned control inputs can be used to adjust the visual information presented on the display assembly 116 or the volume of acoustical energy output by an audio module, as non-limiting examples. The controls can include one of a switch or a button designed to generate a command or a signal that is received by a processor. The control inputs can at least partially extend through openings in the sidewall components. For example, the second sidewall component 106 can include an opening 146 that receives the first control input 142. Further details regarding the features and structure of an electronic device are provided below, with reference to FIG. 2.

FIG. 2 illustrates an exploded view of an electronic device 200. The electronic device 200 shown in FIG. 2 is a smartphone, but is merely one representative example of a device that can include or be used with the systems and methods described herein. As described with respect to electronic device 100, electronic device 200 can correspond to any form of wearable electronic device, a portable media player, a media storage device, a portable digital assistant (“PDA”), a tablet computer, a computer, a mobile communication device, a GPS unit, a remote control device, and other similar electronic devices. In some examples, the electronic device 200 can include some or all of the features described herein with respect to electronic device 100.

The electronic device can have a housing that includes a band 202 that at least partially defines an exterior portion, such as an outer perimeter, of the electronic device. As with the band 102 described above in FIG. 1, the band 202 can include several sidewall components, such as a first sidewall component 204, a second sidewall component 206, a third sidewall component 208 (opposite the first sidewall component 204), and a fourth sidewall component 210. The band 202 can also include a non-metal material or materials that separate and/or join the sidewall components of the band 202 with each other, as described herein. For example, separating material 214 can separate and/or join the second sidewall component 206 with the third sidewall component 208.

The housing, including the band 202, can include one or more features 222 to receive or couple to other components of the device 200. For example, the band 202 can include any number of features such as apertures, cavities, indentations, and other mating features to receive and/or attach to one or more components of the device 200. The electronic device 200 can include internal components such as processors, memory, circuit boards, batteries, and sensors. Such components can be disposed within an internal volume defined, at least partially, by the band 202, and can be affixed to the band 202, via internal surfaces, attachment features 222, threaded connectors, studs, posts, and/or other fixing features, that are formed into, defined by, or otherwise part of the band 202.

The device 200 can include internal components, such as a system in package (SiP) 226, including one or more integrated circuits such as a processors, sensors, and memory. The device 200 can also include a battery 224 housed in the internal volume of the device 200. The device 200 can also include one or more sensors, such as optical or other sensors, that can sense or otherwise detect information regarding the environment exterior to the internal volume of the device 200. Additional components, such as a haptic engine, can also be included in the device 200. The electronic device 200 can also include a display assembly 216, similar to display assembly 116 described herein. In some examples, the display assembly 216 can be received by and/or be attached to the band 202 by one or more attachment features 222. In some examples, one or more of these internal components can be mounted to a circuit board 220.

The electronic device 200 can further include a support plate 230, also referred to as a back plate or chassis, that can perform a number of functions. For example, the support plate 230 can provide structural support for the electronic device 200. The support plate 230 can include a rigid material, such as a metal or metals, as described herein. In some examples, the support plate 230 can have a composite metal construction, including two or more layers of metal, also referred to as cladding layers. The support plate 230 can be physically and/or electrically coupled to the band 202. In this manner, the support plate 230 can, for example, provide an electrical grounding path for components electrically coupled to the support plate 230, such as a compass or an antenna. The support plate 230 can also include one or more attachment features such that one or more components of the electronic device 200 can be attached to the support plate 230, for example, by fasteners or by welding, as described herein. In some examples, the support plate 230 can be joined to the band 202 of the device 200 at one or more locations by the methods described herein.

An exterior surface of the electronic device 200 can further be defined by a back cover 240 that can be coupled to one or more other components of the device 200. In this regard, the back cover 240 can combine with the band 202 to form an enclosure or housing of the electronic device 202, with the enclosure or housing (including band 202 and back cover 240) at least partially defining an internal volume. The back cover 240 can include a transparent material such as glass, plastic, sapphire, or combinations thereof. An inner portion of the back cover 240 can be bonded (e.g., with an adhesive) to the support plate 230. The portion of the support plate 230 that is bonded to the back cover 240 can protrude relative to other peripheral portions thereof, so that welds can be provided within a space that will be between the support plate 230 and the back glass or back cover 240 when assembled. This clearance allows the parts to be assembled without interference between welds on the support plate 230 and the back cover 240. Additionally or alternatively, the back cover 240 can be bonded directly to the band 202 or coupled to the band 202 by an interference or other mechanical engagement.

The housing, including the band 202 can be conformed to interior dimensional requirements, as defined by the internal components. For example, the structure of the device and housing, including a band 202 and a support plate 230, can be defined or limited exclusively or primarily by the internal components the housing is designed to accommodate. Since a housing can be extremely light and strong, the housing can be shaped to house the interior components in a dimensionally efficient manner without being constrained by factors other than the dimensions of the components, such as the need for additional structural elements.

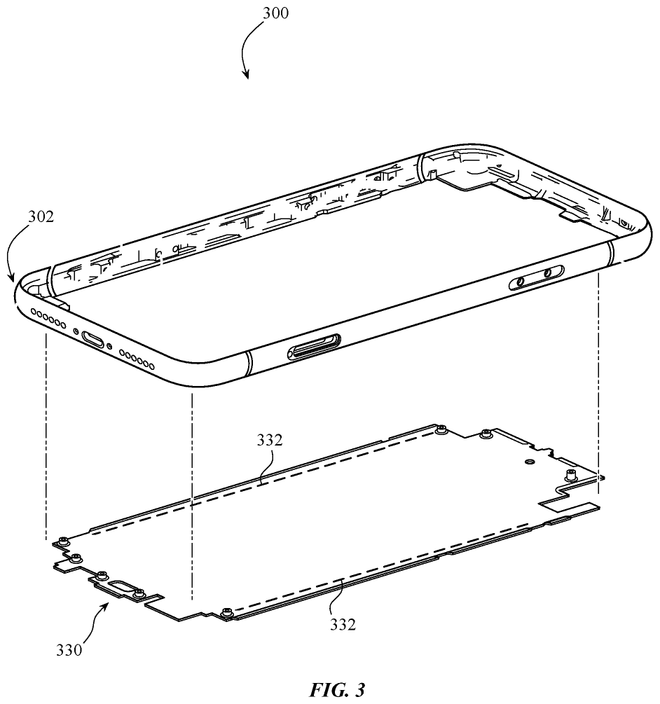

Any number or variety of electronic device components that include dissimilar materials can be joined to include an interface region, as described herein. The process for joining such components including dissimilar materials can include a pulsed laser process, as described herein. The structure and composition of the first material and the second, different material, as well as the interface region between the materials, can apply not only to the specific examples discussed herein, but to any number of examples in any combination. Various examples of joined dissimilar materials and methods of joining the same are described below, with reference to FIG. 3.

FIG. 3 illustrates an exploded view of portions of an electronic device. The electronic device 300 shown in FIG. 3 is a smartphone, and can include any of the features of devices 100 and 200 as described with respect to FIGS. 1 and 2. As with electronic device 100, electronic device 300 can correspond to any form of wearable electronic device, a portable media player, a media storage device, a portable digital assistant (“PDA”), a tablet computer, a computer, a mobile communication device, a GPS unit, a remote control device, and other similar electronic devices.

As with electronic device 200, described above, the electronic device 300 can include a band 302 and a support plate 330. The band can be substantially similar to band 202 described herein, and in some examples, can include several sidewall components. The band 302 can include or be formed from a metallic materials, such as aluminum or stainless steel. For example, the sidewall components forming the band 302 can include a metal, such as an aluminum or a stainless steel alloy.

In some examples, the support plate 330 can be joined to the band 302 by a pulsed laser welding process, as described herein, to provide structural support and/or functional connections between operating components of the electronic device. A support plate 330 can support multiple operable components of the electronic device. The band 302, the welds 332, and/or the support plate 330 can provide electrical connections between components. Conductive pathways provided by the welds 332 can be provided with a high level of strength and durability to reduce and avoid breakage so that sensitive components, such as a compass module, can operate without alterations that would cause interference. The welds 332 can be provided in a sequence that mitigates the effects of heating during the welding process and that reduces the risk of sequential weld failures due to stress. Further, an individual weld 332 can be provided at a length designed to reduce the risk of breakage, both of an individual weld 332, and of the entire welded area of the support plate 330.

As shown in FIG. 3, the support plate 330 can be welded or joined to the band 302 at an outer portion thereof, for example, at locations 332. A weld can have a depth that extends through an entire thickness or height of the support plate 330 and into the band 302. A weld or interface region can have a depth from about 0.1 mm to about 0.5 mm, for example, about 0.2 mm. A weld can extend into the band 302 to a depth of about 0.01 mm to about 0.10 mm, for example, about 0.05 mm. In some examples, a weld or interface region can have a length of about 1000 microns to about 5000 microns, about 1500 microns to about 3000 microns, or about 2000 microns to about 2500 microns. In some examples, a weld or interface region can have a length of about 2440 microns. In some other examples, however, a weld or interface region can have substantially any desired length.

As described herein, the support plate 330 can include a different or dissimilar metallic material from the material of the band 302. In some examples, the band 302 can be or can include aluminum, such as a 6000 series or 7000 series aluminum alloy. The support plate 330, in turn, can be or can include one or both of stainless steel and copper. As described further herein, in some examples, the support plate 330 can include a clad material. The clad material of the support plate 330 can include a copper layer disposed between two stainless steel layers. In some examples, the support plate 330 can have a thickness between about 100 microns and about 1000 microns, between about 150 microns and about 500 microns, or between about 175 microns and about 250 microns. In some examples, the support plate 330 can have a thickness of about 200 microns. In some examples, the support plate 330 can include a copper layer having a thickness of about 100 microns disposed between two stainless steel layers, each having thicknesses of about 50 microns. In some examples, the support plate 330 can include a copper layer having a thickness of about 140 microns disposed between two stainless steel layers each having thicknesses of about 30 microns.

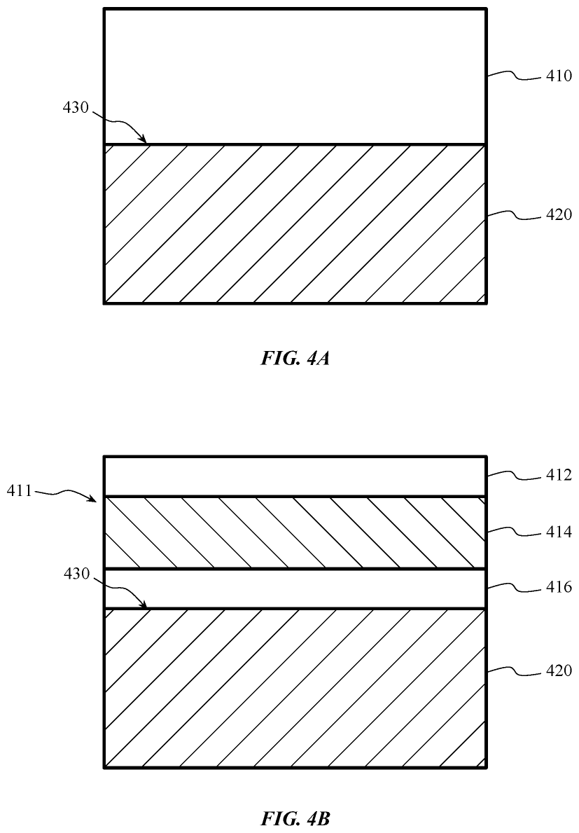

Any number or variety of electronic device components that include dissimilar materials can be joined to include an interface region, as described herein. The process for joining such components including dissimilar materials can include a pulsed laser process. The structure and composition of the first material and the second, different material, as well as the interface region between the materials, can apply not only to the specific examples discussed herein, but to any number of examples in any combination. Various examples of joined dissimilar materials and methods of joining the same are described below, with reference to FIGS. 4A and 4B.

FIG. 4A shows a cross-sectional view of a first material 410 disposed adjacent to a second, different material 420 before being joined by the processes described herein. In some examples, the first material 410 can be a metallic material such as a metal or metal alloy. In some examples, the first material 410 can include copper, a copper alloy, steel, and/or a steel alloy, such as stainless steel. In some examples, the second material 420 can be a metallic material such as a metal or metal alloy. In some examples, the second material 420 can include aluminum. In some examples, the second material 420 can be or include substantially any aluminum alloy. For example, the second material 420 can be a 6000 series or 7000 series aluminum alloy, such as a 6061 aluminum alloy or a 7003 aluminum alloy.

As shown in FIG. 4A, the first material 410 and the second material 420 can be disposed substantially adjacent to one another in at least a region 430 that is to be joined by the processes described herein. In some examples, the surfaces of the first material 410 and the second, different material 420 can be in substantially direct contact with one another in at least the region 430 that is to be joined. In some examples, the surface of one or both of the first material 410 and the second material 420 can be subjected to processing prior to being disposed adjacent to one another. For example, a surface of the first material 410 and/or the second material 420 can be subjected to a cleaning process to prevent undesirable contamination of the weld interface region that is to be formed in the region 430 that is to be joined. In some examples, the first material 410 can have a thickness between about 100 microns and about 1000 microns, between about 150 microns and about 500 microns, or between about 175 microns and about 250 microns. The second material 420 can have any desired thickness, and can be as thin as about 10 microns, or have a thickness up to several tens of millimeters, or even thicker.

As shown in FIG. 4B, in some examples, the first material 411 can be a composite material including two or more metallic materials. In some examples, this composite material 411 can include two or more layers of a metallic material. For example, the first material 411 can be a clad material that includes a central metal layer 414 with layers 412, 416 of a different exterior metal disposed above and below the central metal layer 414. The layers can have a variety of thicknesses. For example, all three layers can have similar thicknesses, while in other examples, the central metal layer 414 can have a thickness greater than the thickness of the different metal layer 412, 416. In some examples, the exterior metal layers 412, 416 can have similar thicknesses to one another or can have different thicknesses. In some examples, the first material 411 can include a copper layer 414 having a thickness of about 100 microns disposed between two stainless steel layers 412, 416, each having thicknesses of about 50 microns. In some examples, the first material 411 can include a copper layer 414 having a thickness of about 140 microns disposed between two stainless steel layers 412, 416 each having thicknesses of about 30 microns.

As used herein, the terms first material and second material are used for reference only, and are not intended to indicate or imply any order or relation between the materials, or any process including the materials. For example, a second material can be provided, formed, or treated first in a process involving first and second materials. Further, in some examples, the second material can overlie the first material, while in other examples, the first material can overlie the second material. Accordingly, the terms first material and second material are not intended to limit the materials, or any process involving the materials, in any way.

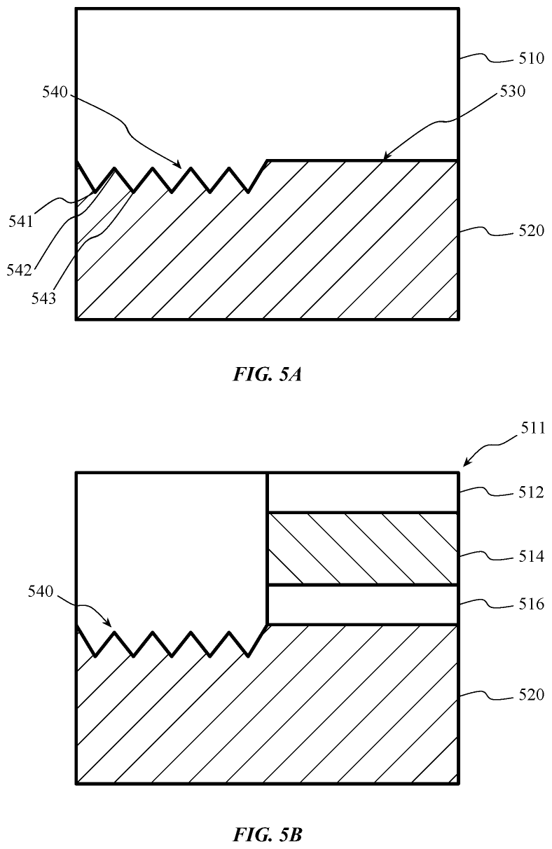

Any number or variety of electronic device components that include dissimilar materials can be joined to include an interface region, as described herein. The process for joining such components including dissimilar materials can include a pulsed laser process, as described herein. The structure and composition of the first material and the second, different material, as well as the interface region between the materials, can apply not only to the specific examples discussed herein, but to any number of examples in any combination. Various examples of joined dissimilar materials, and methods of joining the same are described below, with reference to FIGS. 5A and 5B.

FIG. 5A shows a cross-sectional view of a first material 510 disposed adjacent to a second, different material 520, with the first material 510 joined to the second material 520 by a weld interface region 540 that has been formed according to the pulsed laser welding processes described herein. FIG. 5A depicts an intermediate stage of the joining process, wherein the interface region 540 has not yet been formed along the entire desired length 530 between the first material 510 and the second material 520.

In some examples, a pulsed laser welding process, such as a nanosecond pulse laser welding process, can be used to join the first material 510 to the second material 520 by forming the interface region 540 between the materials. The term interface region is used herein to refer to a region wherein two or more abutting materials have been melted, at least locally, and fused, joined, or otherwise bonded together. An interface region can include mixing of the joined materials on a microscopic and/or macroscopic level. The bond formed between materials at an interface region can be a result of chemical bonding, physical or mechanical bonding, metallurgical bonding, or any combination thereof.

The interface region 540 can have a structure that includes a number of extension areas or peaks 542 and depression areas or valleys 541, where the first material 510 extends into the second material 520 to form the interface region 540. In some examples, the interface region 540 can be formed by exposing at least the first material 510 to a laser pulse at a first location and then exposing at least the first material 510 to a second laser pulse at a second location substantially adjacent to the first location. In this way, the laser pulses translate across the region 530, forming and extending the interface region 540 as the laser moves. In the example depicted in FIG. 5A, the first material 510 was exposed to an initial laser pulse at a first location to form valley 541, and a second pulse at a second location to form valley 543 substantially adjacent to valley 541. The location at which laser pulses were supplied continued to translate, here depicted from left to right, to continue forming the interface region 540. FIG. 5A illustrates an intermediate stage of this interface region formation process, wherein the interface region 540 is still to be formed in region 530 by continued exposure to laser pulses. FIG. 5B illustrates an alternative configuration.

FIG. 5B shows a cross-sectional view of a first material 511 including multiple layers of metallic material 512, 514, 516 disposed adjacent to a second, different material 520. As with FIG. 5A, the materials 511, 520 are joined along an interface region 540 that is formed by exposing at least the first material 511 to laser pulses. Further, as can be seen in FIG. 5B, exposing the first material 511 to a laser pulse can melt and intermix the material of layers 512, 514, 516. Accordingly, once the first material 511 has been exposed to a laser pulse to form an interface region 540 with second, different material 520, that region 518 of the first material 511 can be a mixture of the material of the layers 512, 514, 516 of the first material 511. In some examples, such as where layer 514 includes copper and layers 512, 516 include stainless steel, the intermixed region 518 can be a substantially homogenous mixture of copper and stainless steel.

As described herein, the laser pulses used to form the interface region 540 can have a specified focal distance or focal point at which the laser energy is concentrated. In some examples, a laser pulse can have a focal distance that is positioned substantially at the region 530 where the first material 510, 511 contacts or abuts the second material 520. In some examples, the focal distance or focal point of a laser pulse can be offset from the contact area 530 between the first material 510, 511 and the second material 520. In some examples, the focal point can be up to about 0.5 mm below the contact region 530, that is, up to a distance of about 0.5 mm below the surface of the second material 520. In some examples, the focal point can be up to about 0.4 mm, up to about 0.3 mm, up to about 0.25 mm, up to about 0.2 mm, or up to about 0.1 below the contact region 530. Accordingly, because the focal point of the laser pulse can extend into the second material 520, in some examples, both the first material 510, 511 and the second material 520 can be exposed to the laser pulse. In some examples, the focal point can be up to about 0.5 mm above the contact region 530, that is, up to a distance of about 0.5 mm above the surface of the second material 520. In some examples, the focal point can be up to about 0.4 mm, up to about 0.3 mm, up to about 0.25 mm, up to about 0.2 mm, or up to about 0.1 mm above the contact region 530.

In some examples, this focal point or focal distance can be held relatively constant as the laser pulse translates and forms the interface region 540. In some examples, however, the focal distance can vary, for example, due to thermal effects from the first material 510, 511, the second material 520, or a variety of other reasons. In some examples, where the focal distance can vary, however, it can still be maintained within a desired range, such as the range of focal distances described above, for the duration of the laser welding process to form the interface region 540.

In some examples, a laser pulse can have a desired push force. The push force of the laser pulse is the amount of force exerted on the material being exposed to the laser pulse and is at least partially determined by the laser power, as well as the focal distance and a variety of other factors. In some examples, the push force of a laser pulse used to form the interface region 540 can be between about 30 kilograms of force (kgf) and about 70 kgf. In some examples, the push force of a laser pulse can be between about 40 kgf and about 65 kgf. In some examples, the push force can be between about 50 kgf and about 65 kgf. In some examples, the push force can be about 65 kgf. In some examples, the push force of the laser pulse used to form the interface region 540 can be selected to provide a strong and durable bond between the two dissimilar materials, as desired. If the push force is too low, the average height of the peaks 541, 543 and valleys 542 are often insufficient to form a reliable bond between the two materials. In some examples, if the push force is too high then the laser pulse can produce too much intermixture between the two dissimilar materials, which can result in the formation of brittle intermetallic materials that can significantly reduce the strength of the bond at the interface region 540.

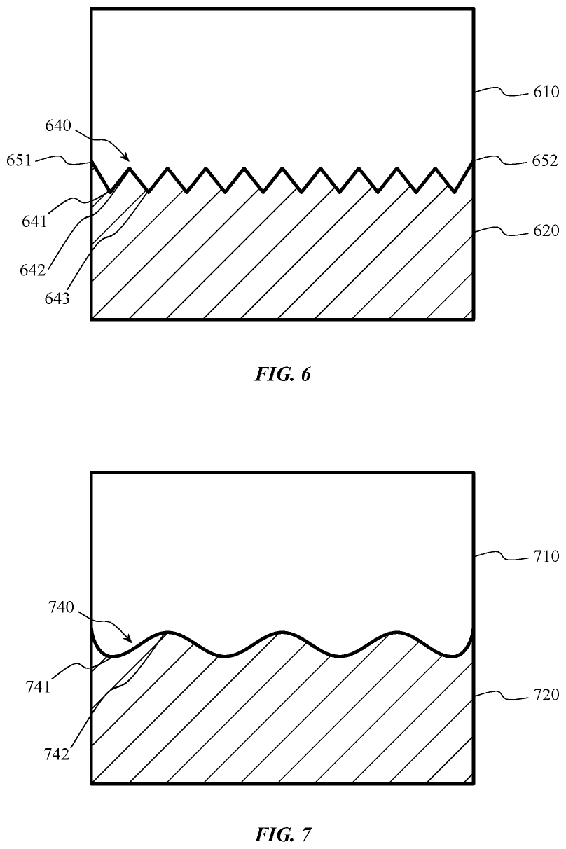

Any number or variety of electronic device components that include dissimilar materials, can be joined to include an interface region, as described herein. The process for joining such components including dissimilar materials can include a pulse laser process, as described herein. The structure and composition of the first material and the second, different material, as well as the interface region between the materials, can apply not only to the specific examples discussed herein, but to any number of examples in any combination. Various examples of joined dissimilar materials and methods of joining the same are described below, with reference to FIG. 6.

FIG. 6 shows a cross-sectional view of a first material 610 joined to a second, different material 620 by or along an interface region 640 that has been formed according to the pulsed laser welding processes described herein. In some examples, the first material 610 can be substantially similar to the first materials 410, 411, 510, and 511 described above, while the second material 620 can be substantially similar to the second materials 420, 520 described above. The interface region 640 can be formed in a substantially similar manner to interface region 540, for example, by a nanosecond pulse laser welding process.

As can be seen in FIG. 6, the interface region 640 can extend between a first point of contact 651 or end point between the materials 610, 620 and a second point of contact 652 or end point between the materials 610, 620. In some examples, components of an electronic device can be joined by multiple interface regions 640 that can be apart from one another by a desired distance, for example, by about 0.1 mm, 0.5 mm, 1 mm, 2 mm, or more. Although not shown in FIG. 6, the first material 610 can still contact or abut the second material 620 at locations adjacent to the points of contact 651, 652, but an interface region is not necessarily formed in those regions. Accordingly, FIG. 6 shows then entire length of an interface region 640 between the first material 610 and the second material 620. Further, while the interface region 640 can have a depth, that is, the interface region 640 can extend into or out of the page, the cross-section of FIG. 6 is taken substantially along the center of the interface region 640.

As with the interface region 540 described above, the interface region 640 can have a jagged or saw tooth shape, including a number of features, such as interlocking or engaging peaks 642 and valleys 641, 643. The peaks 642 and valleys 641, 643 can be formed by substantially planar intersecting surfaces. The formation of these features can serve to extend the total length of the interface region, thereby forming a strong a durable bond between the materials, as desired. In some examples, features, such as features 641, 642, 643, can have an average height, or a distance between a topmost portion of the feature and a bottommost portion of the feature of less than about 100 microns, for example, between about 50 microns and about 100 microns, or between about 50 microns and about 75 microns. In some examples, a feature, such as peak 642 can have a feature width of from about 50 microns to about 75 microns, for example, about 65 microns. Owing to the formation of these jagged or saw tooth features of the interface region 640 by the pulse laser welding process, the total length of the interface region can be greater than a straight-line distance between the endpoints 651, 652 of the interface region 640.

The term interface region length is used herein to refer to the total length of an interface between the interface region and either of the two materials that are joined by the interface region, such as interface region 640, while the term lateral length is used to refer to the straight-line distance between the endpoints the interface region, such as the straight-line distance between points 651 and 652. Although referred to as a lateral length, in some examples, the spatial orientation of the interface region can mean that the lateral length can, in fact, have any orientation in space and need not be lateral or horizontal. In some examples, an interface region such as interface region 640 can have a ratio of an interface region length to a lateral length of at least about 1.4, at least about 1.5, at least about 1.6, at least about 1.7, at least about 1.8, or even greater. In some examples, an interface region 640 can have a ratio of an interface region length to a lateral length up to about 1.8, for example, between about 1.4 and about 1.8. In some examples, the lateral length of an interface region 640 can be between about 1000 microns and about 5000 microns, for example, about 2500 microns. Accordingly, where the lateral length of the interface region 640 is about 2500 microns, the interface region length can be between about 3500 microns and about 4500 microns. In some examples, the interface region length of an interface region 640 can be about 4000 microns.

The interface region 640 can also include a relatively small amount of intermetallic material formed by the pulsed laser welding process. The terms intermetallic, intermetallics, or intermetallic material are used herein to refer to solid phases containing two or more metallic elements, for example, both the first material 610 and the second material 620, whose crystal structure differs from that of the constituents. These intermetallic materials can be substantially more brittle than either the first material 610 or second material 620, and their formation can result in a weak interface region 640 that can be prone to brittle fracture under lower than desired loads. Accordingly, it is desirable to form the interface region 640 without forming an undesirably high amount of brittle intermetallics, as will be discussed further herein.

These brittle intermetallics can have a hardness greater than a hardness of either the first material 610 or the second material 620, and as such, they can be detected by measuring a hardness value of the interface region 640 itself. In some examples, an interface region can have a hardness less than about 2.5 times, 2 times, 1.5 times, 1 time, or even less than the hardness of the first material. The hardness of an interface region, such as interface region 640, can be determined by exposing a cross-section along the entire length of the interface region that is positioned substantially at the center of the depth (that is, the axis extending into and out of the page in FIG. 6) of the interface region, and performing a hardness test, such as a Vickers hardness test on the exposed cross-section.

While some level of intermixing of the first material 610 and the second material 620 can be desirable to form a strong and durable bond, too much intermixing can, as described above, result in the formation of undesirable intermetallics. Thus, in some examples, an interface region 640 having an increased strength can have a desired concentration of the second material 620. In some examples, the interface region 640 can include less than about 25 weight percent (wt %) of the second material 620, less than about 20 wt %, less than about 15%, less than about 10 wt %, or less than about 5 wt % or even lower. In some examples, the interface region 640 can be substantially free of the second material 620. That is, in some examples, the interface region 640 can be considered the region where the first material 610 has been melted and bonded to the second material 620, but does not include the second material 620 itself because there is a substantially clear delineation between the interface region 640 and the second material 620.

In some examples, as described herein, the second material 620 can include aluminum. Thus, in some examples, the interface region 640 can include less than about 25 weight percent (wt %) aluminum, less than about 20 wt % aluminum, less than about 15% aluminum, less than about 10 wt % aluminum, or less than about 5 wt % aluminum, or even lower. In some examples, the interface region 640 can be substantially free of aluminum, only including the first material 610, for example, copper and/or steel. Various examples of joined dissimilar materials and methods of joining the same are described below, with reference to FIGS. 7-11.

FIG. 7 shows a cross-sectional view of a first material 710 joined to a second, different material 720 by or along an interface region 740. In some examples, the first material 710 can be substantially similar to the first material 610 described above, while the second material 720 can be substantially similar to the second material 620 described above. In contrast to the interface region 640 described with respect to FIG. 6, however, the interface region 740 has a structure that does not produce a reliable and strong bond between the two materials 710, 720. Thus, interface region 740 is an example of an undesirable interface region between two dissimilar materials. For example, as shown in FIG. 7, the feature 741, 742 of the interface region 740 are substantially wider and more rounded at their peak than the features of interface region 640. The features 741, 742 can be valleys and peaks, respectively, and can be formed by curvilinear intersecting surfaces. The rounded peaks 742 and valleys 741 can mate, mesh, or interlock with corresponding features in the opposite material. Further, the features 741, 742 can have a height less than about 50 microns. As a result, the interface region 740 will not likely have enough mechanical interlock, mixing, or interpenetration between the first material 710 and the second material 720 to join the materials together with an increased strength, as described herein.

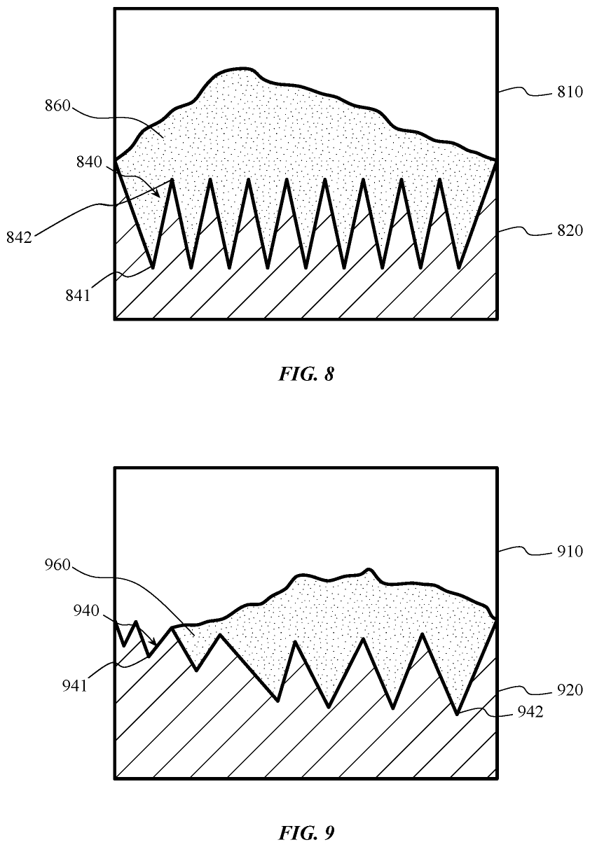

In some examples, the structure of the undesirable interface region 740 can be formed by a pulsed laser welding process wherein the laser pulses do not achieve a desired push force, for example, greater than about 30 kgf. This can be a result of a laser that does not have enough power, or from a focal distance that is located too far from the contact point between the materials 710, 720, for example, greater than about 0.5 mm above the contact point. This undesirable structure can also be the result of laser pulses that have too long of a duration, for example, greater than about 300 nanoseconds, or even greater than about 250 nanoseconds, or that have too wide of a focal area, thereby forming features with widths greater than about 75 microns or about 100 microns. Consequently, the undesirable interface region 740 has a ratio of an interface region length to a lateral length of less than about 1.4, thereby resulting in a bond between the materials 710, 720 that does not achieve a desired increased strength. Additional details of a first material joined to a second material are illustrated and described below with reference to FIG. 8.

FIG. 8 shows a cross-sectional view of a first material 810 joined to a second, different material 820 by or along an interface region 840. In some examples, the first material 810 can be substantially similar to the first material 610 described above, while the second material 820 can be substantially similar to the second material 620 described above. As with FIG. 7, the interface region 840 illustrated in FIG. 8 is an example of an interface region having an undesirable structure, resulting in a bond between the materials 810, 820 that does not have a desired level of performance. Whereas FIG. 7 illustrated an interface region that had insufficient feature heights or widths, in the example shown in FIG. 8 the features 841, 842 have a height that is too large, and thus an interface region length to lateral length ratio that is too large, for example, greater than about 2.

This undesirably large feature height, for example, greater than about 150 microns, can be the result of a laser welding process that included laser pulses with too large of a push force, for example, greater than about 70 kgf, and/or a focal point located too far below the surface of the second material 820, for example, greater than about 0.5 mm below the surface. As a result, too much energy has been delivered to the materials 810, 820, resulting in increased mixture and the formation of brittle intermetallics 860 at the interface region 840.

Although not illustrated in FIG. 6, a bond between two dissimilar materials, as described herein, can include some amount of intermetallics below a desired threshold. The amount of intermetallics in an interface region, such as interface region 640 or 840 can be determined by taking a cross-section at the center of the interface region including its entire length, for example, as described above with respect to FIG. 6, and measuring the exposed area of intermetallic material. In some examples, the intermetallic material 860 can be visually distinguished from the first material 810 or second material 820, for example, based on the color of the intermetallic material. The interface region 840 has an undesirably high amount of intermetallics, resulting in a region of intermetallic material having an area greater than about 5.5 times the interface region length. Accordingly, in some examples, an interface region, such as interface region 640 described above, can have a region of intermetallic material with an area less than about 5.5 times the interface region length, for example, less than about 5 times, less than about 4 times, less than about 3, 2, or 1 times the interface region length or even smaller.

FIG. 9 shows a cross-sectional view of a first material 910 joined to a second, different material 920, by or along an interface region 940. In some examples, the first material 910 can be substantially similar to the first material 610 described above, while the second material 920 can be substantially similar to the second material 620 described above. As with FIGS. 7 and 8, the interface region 940 illustrated in FIG. 9 is an example of an interface region 940 having an undesirable structure, resulting in a bond between the materials 910, 920 that does not have a desired level of performance. The interface region 940 contains some features, such as feature 941 that have a desired height, but also additional features, such as feature 942 that are too large, resulting in an undesirably large average feature height, for example, greater than about 100 microns.

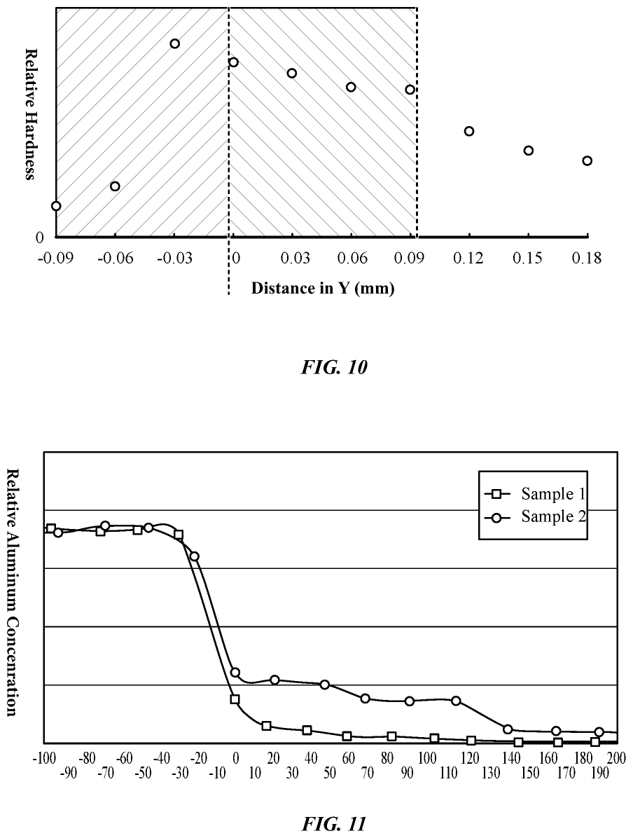

The structure of the interface region 940 can be the result of undesirable variance in one or more of the laser parameters during a pulsed laser welding process. For example, the push force or focal distance can have undesirably increased during formation of the interface region 940 as the laser was translated from left to right. This variance can be due to many factors, such as undesirable operational parameters of the laser welding system, or from thermal expansion of the materials 910, 920 due to component geometry, forming multiple interface regions too close together, or forming an interface region that is too long, As can be seen in FIG. 9, the increased intermixture of the materials 910, 920 caused by the variance has resulted in the formation of an undesirably large region of intermetallics 960. Details regarding material properties achievable with the present methods are provide below, with reference to FIG. 10

FIG. 10 depicts a plot showing relative material hardness versus distance from an interface region, for example, interface region 840 shown in FIG. 8, that has an undesirably high level of intermetallics. As described with respect to FIG. 6, the hardness of the interface region between two joined dissimilar materials can be measured to determine a concentration of intermetallic materials. In FIG. 10, the interface region is located at 0 on the y-axis and extends about 0.09 mm into the first material. Thus, the second material extends to the left from the 0 point on the y-axis. In some cases, hardness measurements were taken by performing a Vickers hardness test on a cross-section through the center of the interface region, including the entire interface region length, at various distances along the interface region.

The first material, in this example is an aluminum alloy. As the measurement positions move closer to the interface region, it can be seen that the hardness value increases above an undesirable amount, here reaching as high as about 4 times the hardness of the aluminum alloy. This is indicative of the presence of very hard, but brittle intermetallics in the interface region. As the measurement position continues through the interface region, the hardness values stay undesirably high, above about 3 times the hardness of the aluminum alloy, before dropping back down, as the measurement location moves to a region that is primarily first material. In addition to hardness indicators, intermetallics can be detected by material concentrations, as detailed below with reference to FIG. 11. In some cases, the undesirable intermetallic material can have a hardness about 2.5 times, 3 times, 4 times, or even greater than the hardness of the aluminum alloy.

FIG. 11, shows a plot of the relative concentration of the second material (wt %), which in this example, is an aluminum alloy, versus distance from an interface region in microns for two samples, Sample 1 and Sample 2. In this example, Sample 1 is an interface region having a structure, such as the structure illustrated in FIG. 6, that results in a high desired level of performance and interface region strength and durability, while Sample 2 is an interface region having a structure that results in an undesirable level or performance, for example, as shown in FIG. 8.

Starting from the left side of the plot, at a distance of about 100 microns below the surface of the second material, here aluminum, it can be seen that the aluminum concentration of both samples is about 95%, which is the aluminum concentration of the alloy forming the second material. As the interface region is approached, the aluminum concentration begins to drop. In Sample 1, which has a desired level of intermixture between the two dissimilar materials at the interface region, the aluminum concentration drops to below about 10 wt % through the entire extent of the interface region, before dropping substantially to zero at about 100 microns from the surface of the second material. This is indicative of an interface region that includes feature heights in a desirable range, for example, less than about 100 microns.

In contrast, the aluminum concentration of Sample 2 is greater than about 25 wt % well into the interface region and only drops off at a distance of about 120 microns from the surface of the second material. This is indicative of an interface region including features greater than a desired height, for example, greater than about 120 microns, which has resulted in too much intermixture and the formation of intermetallics. Further, as can be seen in FIG. 11, the aluminum concentration of Sample 2 stays at a relatively elevated level well away from the interface region, again indicating an undesirable amount of intermixture between the two dissimilar materials, for example, due to an undesirably large push force or improper focal distance.

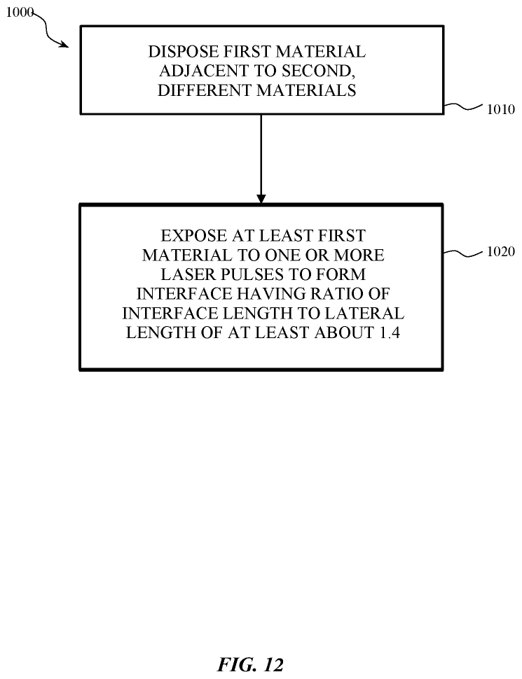

Any number or variety of electronic device components that include dissimilar materials can be joined to include an interface region, as described herein. The process for joining such components including dissimilar materials can include a pulsed laser process, as described herein. The structure and composition of the first material and the second, different material, as well as the interface region between the materials, can apply not only to the specific examples discussed herein, but to any number of examples in any combination. Various examples of joined dissimilar materials and methods of joining the same are described below, with reference to FIG. 12.

FIG. 12 illustrates a process flow diagram of a process for joining a first material to a second, different material, as described herein. The process 1000 for joining two dissimilar metallic materials can include disposing a first metallic material adjacent to a second, different metallic material at block 1010. The process 1000 can also include exposing at least the first metallic material to one or more laser pulses to form an interface region between the first and second materials having a ratio of an interface region length to a lateral length of at least about 1.4, at block 1020.

At block 1010, a first material can be disposed substantially adjacent to or abutting a second, different material. That is, in some examples, a surface of the first material can be brought into direct contact with a surface of the second, different material to which the first material is to be joined. In some examples, the surface of the first and/or second material can be subjected to processing prior to being brought into contact with one another. For example, in some examples, a surface of the first material and/or the second material can be subjected to a cleaning process to prevent undesirable contamination of the weld interface region that is to be formed. In some examples, a surface of the first and/or second material can be subjected to a process to remove any native oxide layer that can be present on the surface, for example, by etching or polishing. For example, where the second material includes aluminum, any native aluminum oxide layer can be removed from the surface by an etching process prior to disposing a surface of the first material adjacent thereto.

As described herein, the first material can be a metallic material, such as a metal or metal alloy. In some examples, the first material can include copper, a copper alloy, steel, and/or a steel alloy, such as stainless steel. In some examples, the first material can be a composite material including two or more metallic materials, as described herein. In some examples, this composite material can include two or more layers of metallic material. For example, the first material can be a clad material that includes a central metal layer with layers of a different exterior metal disposed above and below the central metal layer. In some examples, the first material can have a thickness between about 100 microns and about 1000 microns, between about 150 microns and about 500 microns, or between about 175 microns and about 250 microns. In some examples where the first material includes multiple layers, each layer can range in thickness from about a micron up to about 1000 microns, as described herein.

The second material can be a metallic material such as a metal or metal alloy. In some examples, the second material can include aluminum. In some examples, the second material can be or include substantially any aluminum alloy. For example, the second material can be a 6000 series or 7000 series aluminum alloy, such as a 6061 aluminum alloy or a 7003 aluminum alloy. The second material can have substantially any desired thickness.

At block 1020, at least the first material is exposed to one or more laser pulses to join and form an interface region between the first and second materials having a ratio of an interface region length to a lateral length of at least about 1.4, as described herein. In some examples, block 1020 can include a pulsed laser welding process, such as a nanosecond pulsed laser welding process. That is, in some examples, the interface region is formed by exposing at least the first material to a laser pulse at a first location and then exposing at least the first material to a second laser pulse at a second location substantially adjacent to the first location. In this way, the laser pulses translate laterally, forming and extending the interface region as the laser pulses impact adjacent locations of material.

In some examples where multiple laser pulses are supplied to at least the first material, the laser pulses can have a substantially similar pulse time, focal distance, push force, and pulse shape to one another. In some examples, as explained with respect to FIGS. 5A and 5B, the laser pulses can have an average focal distance of up to about +/−0.5 mm, up to about +/−0.4 mm, up to about +/−0.3 mm, up to about +/−0.25 mm, up to about +/−0.2 mm, or up to about +/−0.1 mm from a point of contact between the first and second materials. Further, in some examples, the laser pulses of block 1020 can have an average push force between about 30 kilograms of force (kgf) and about 70 kgf. In some examples, the average push force can be between about 40 kgf and about 65 kgf. In some examples, the average push force can be between about 50 kgf and about 65 kgf. In some examples, the average push force can be about 65 kgf.

In some examples, the laser pulses can impact the material with a frequency of between about 750 kHz to about 900 kHz. In some examples, an individual laser pulse can have a duration of between about 100 nanoseconds and about 500 nanoseconds, for example, between about 200 nanoseconds and about 300 nanoseconds. In some examples, a laser pulse can have a duration of about 240 nanoseconds. Each laser pulse can also impact the material with a pulse energy. In some examples, the pulse energy of a single pulse, or the average pulse energy of multiple laser pulses can be between about 50 microjoules (μJ) and about 100 μJ, for example between about 75 μJ and about 95 μJ, or between about 78 μJ and about 93 μJ.

Subsequent to block 1020, the joined first material and second material can be subjected to further treatment or processing. For example, where the first material is a first component, such as a support plate, and the second material is a second component, such as a band of an electronic device, the joined support plate and band can be subjected to further processing including further assembly of the electronic device, as described herein.

Any of the features or aspects of the processes for joining dissimilar materials or the interface regions between dissimilar materials, as described herein can be combined or included in any varied combination. For example, the design and shape of any component including a first metallic material is not limited in any way and can be joined to a second, different material to form an interface region by any number of processes, including those discussed herein. While certain exemplary first and second materials have been discussed, the first material can include any amount of copper and/or steel and can include any structure, such as a layered structure or a mixed structure. Similarly, the second material can include any form of aluminum alloy, and the structure or size of a component including the second material is not limited in any way. The processes and interface regions formed therefrom can be used to join any number of dissimilar materials in additional components of an electronic device, including internal components, external components, examples, surfaces, or partial surfaces.

As described above, one aspect of the present technology is the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

As used herein, the terms exterior, outer, interior, inner, top, and bottom are used for reference purposes only. An exterior or outer portion of a composite component can form a portion of an exterior surface of the component, but may not necessarily form the entire exterior of outer surface thereof. Similarly, the interior or inner portion of a composite component can form or define an interior or inner portion of the component, but can also form or define a portion of an exterior or outer surface of the component. A top portion of a component can be located above a bottom portion in some orientations of the component, but can also be located in line with, below, or in other spatial relationships with the bottom portion depending on the orientation of the component.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. An electronic device, comprising:
a first metallic material;
a second, different metallic material joined to the first metallic material; and
an interface region between the first metallic material and the second metallic material, the interface region having a ratio of an interface region length to a lateral length of at least about 1.4.

2. The electronic device of claim 1, wherein a cross-sectional area of the first and second metallic materials including the interface region length contains a region of intermetallic material having an area of less than about 5.5 times the interface region length.

3. The electronic device of claim 1, wherein the interface region includes less than about 25 weight percent (wt %) aluminum.

4. The electronic device of claim 1, wherein the interface region has a hardness less than about 2.5 times a hardness of the first material.

5. The electronic device of claim 1, wherein the first material includes aluminum and the second material includes at least one of steel or copper.

6. The electronic device of claim 1, wherein the interface region includes one or more peaks of the first material extending into the second material, the peaks having an average extension into the second material of less than about 100 microns.

7. The electronic device of claim 6, wherein the peaks have an average extension into the second material of less than about 75 microns.

8. The electronic device of claim 1, wherein the interface region length is at least about 3500 microns.

9. The electronic device of claim 1, wherein the interface region length is at least about 4000 microns.

10. A method of joining two dissimilar metallic materials, comprising:
disposing a first metallic material adjacent to a second, different metallic material;
exposing at least the first metallic material to at least one nanosecond laser pulse to form an interface region between the first and second metallic materials having a ratio of an interface region length to a lateral length of at least about 1.4

11. The method of claim 10, wherein a push force of the nanosecond laser pulse is greater than about 50 kilogram-force (kgf).

12. The method of claim 10, wherein the nanosecond laser pulse has a duration of from about 200 nanoseconds to about 300 nanoseconds.

13. The method of claim 12, wherein the nanosecond laser pulse has a duration of about 240 nanoseconds.

14. The method of claim 10, wherein the nanosecond laser pulse has a power of from about 75 microjoules (0) to about 100 μJ.

15. The method of claim 10, wherein a focal position of the nanosecond laser pulse is between about 0.5 mm above a surface of the second metallic material and about 0.5 mm below a surface of the second metallic material.

16. The method of claim 10, wherein a cross-sectional area of the first and second metallic materials and the interface region contains a region of intermetallic material having an area of less than about 5.5 times the interface region length.

17. The method of claim 10, wherein the interface region includes less than about 25 weight percent (wt %) aluminum.

18. An interface region between a first metallic material and second, different metallic material having a ratio of an interface region length to a lateral length of at least about 1.4.

19. The interface region of claim 18, wherein the first metallic material includes stainless steel and copper and the second metallic material includes aluminum.

20. The interface region of claim 18, wherein the ratio of the interface region length to the lateral length is at least about 1.8.
